(19) United States
(12) Patent Application Publication
(10) Pub. No.: US 2013/0339346 A1
(43) Pub. Date: Dec. 19, 2013

(54) MOBILE TERMINAL AND MEMO SEARCH METHOD FOR THE SAME

(71) Applicant: Samsung Electronics Co., Ltd., Gyeonggi-do (KR)

(72) Inventor: Sungjae CHO, Seoul (KR)

(73) Assignee: Samsung Electronics Co., Ltd., Gyeonggi-do (KR)

(21) Appl. No.: 13/900,890

(22) Filed: May 23, 2013

(30) Foreign Application Priority Data
Jun. 15, 2012 (KR) 10-2012-0064241

(51) Int. Cl. G06F 17/30

(52) U.S. Cl. CPC G06F 17/30554
USPC 707/722

(57) ABSTRACT

A mobile terminal and memo search method for the same enable the mobile terminal to perform a memo search on the basis of input information on a memo. The memo search method includes: collecting, when a memo is input, input information on the memo; creating a search database on the basis of the input information; and storing the memo and the search database in an associated form. In addition, the memo search method includes: inputting a search word for memo search; collecting input information on the search word; searching a search database containing input information on stored memos for a memo matching the input information on the search word; and displaying the memo search results.

### CLAIM OF PRIORITY

This application claims, pursuant to 35 U.S.C. §119(a), priority to and the benefit of the earlier filing date of a Korean patent application filed on Jun. 15, 2012 in the Korean Intellectual Property Office and assigned Serial No. 10-2012-0064241, the entire disclosure of which is hereby incorporated by reference.

### BACKGROUND

1. Field of the Invention

The present disclosure relates to a memo search method for a mobile terminal and, more particularly, to a mobile terminal and memo search method for the same wherein memo input information is used to perform a memo search.

2. Description of the Related Art

As advanced mobile terminals such as smart phones and tablet computers provide diverse and convenient functions, many users write and use memos with their mobile terminals. Utilization of memo functions of mobile terminals has become active as handwriting input using electronic pens has been made more convenient.

In the prior art, beyond simple memo applications, efforts are made to develop a memo management technique that enables a user to write and store a memo in the course of executing any function or application of a mobile terminal.

More specifically, with such a memo management technique, the user may write and store memos while executing various functions of the mobile terminal including web surfing, education, entertainment, music or movie applications. In addition, the user may search stored memos for particular content.

To find a desired memo among stored memos using an existing memo function of a mobile terminal, the user may have to open each memo to check the contents thereof or to enter characters to be compared with characters output by character recognition of stored memos.

To find a desired memo, the user may have to preview stored memos through thumbnails or snapshots.

Such a memo search method may produce inaccurate search results and take a long time in the case of a large number of memos, causing user inconvenience.

Hence, it is necessary to provide a memo search method that enables the user of a mobile terminal to accurately find a desired memo among a large number of memos.

### SUMMARY

The present invention addresses and solves the above problems, in that the present invention provides a mobile terminal and memo search method for the same wherein input information during memo writing is collected and stored in a search database and a memo search is performed using the search database.

The present invention also provides a mobile terminal and memo search method for the same wherein input speed or input speed change during memo writing is collected and stored in a search database, and input speed or input speed change when entering search words is collected and used for a memo search based on the search database.

In accordance with an exemplary embodiment of the present invention, there is provided a memo search method including: collecting, when a memo is input, input information on the memo; creating a search database on the basis of the input information; and storing the memo and the search database in an associated form.

The input information may include information obtained from a memo input and information derived therefrom, and may be related to at least one of input time, length, speed, speed change, pressure, pressure change, width, and width change.

The search database may contain input information, which is composed of information obtained from a memo input and information derived therefrom and is related to at least one of input time, length, speed, speed change, pressure, pressure change, width, width change, and memo information corresponding to the input information.

Creating a search database may include: computing, when the input information includes input time and length, at least one of input speed and speed change on the basis of input time and length; and creating a search database on the basis of the input information and computation results.

Collecting input information on the memo may include collecting input information during a preset period during memo input, and creating a search database may include creating a search database on the basis of the input information collected according to the preset period.

Creating a search database may include: computing, when the input information includes an input length per period collected during a preset period, at least one of input speed and speed change per period on the basis of input length per period; and creating a search database on the basis of the input information and computation results.

The memo search method may further include: inputting a search word for memo search; collecting input information on the search word; searching the search database for a memo matching the input information; and displaying the memo search results.

Searching the search database for a memo may include: performing pattern matching between the input information of the search word and the search database; and obtaining memo search results on the basis of the pattern matching results.

In accordance with another exemplary embodiment of the present invention, there is provided a memo search method including: inputting a search word for a memo search; collecting input information on the search word; searching a search database containing input information on stored memos for a memo matching the input information on the search word; and displaying the memo search results.

Collecting input information may include collecting input information on the search word during a preset period during input of a search word.

Searching a search database may include: computing, when the input information includes input time and length, at least one of input speed and speed change on the basis of input time and length; and searching the search database for a matching memo on the basis of the input information and computation results.

Searching a search database may include: performing pattern matching between the input information of the search word and the search database; and obtaining memo search results on the basis of the pattern matching results.

In accordance with another exemplary embodiment of the present invention, there is provided a mobile terminal including: an input unit receiving user input; a storage unit storing data; and a control unit collecting, when a memo is input through the input unit, input information on the memo, creating a search database on the basis of the input information, and storing the memo and the search database in an associated form in the storage unit.

The control unit may compute, when the input information includes input time and length, at least one of input speed and speed change on the basis of input time and length, and create the search database on the basis of the input information and computation results.

The mobile terminal may further include a display unit displaying data, and the control unit may collect, when a search word for a memo search is input through the input unit, input information on the search word, search the search database for a memo matching the input information, and control the display unit to display the memo search results.

The control unit may perform pattern matching between the input information of the search word and the search database, and obtain the memo search results on the basis of the pattern matching results.

### BRIEF DESCRIPTION OF THE DRAWINGS

The features and advantages of the present invention will be more apparent from the following detailed description in conjunction with the accompanying drawings, in which:

FIG. 1 is a block diagram of a mobile terminal supporting a memo search function according to an exemplary embodiment of the present invention;

FIG. 2 is a flowchart of a memo input procedure for a memo search according to another exemplary embodiment of the present invention;

FIG. 3 illustrates an input memo;

FIGS. 4, 5, 6, 7, and 8 illustrate the collection of information on input speed or input speed change as input information;

FIG. 9 is a flowchart of a memo search method according to another exemplary embodiment of the present invention;

FIG. 10 illustrates an input search word;

FIG. 11 illustrates a graph showing results of pattern matching using input speed as input information; and

FIGS. 12 and 13 illustrate search result displays.

### DETAILED DESCRIPTION

Hereinafter, preferred embodiments of the present invention are described in detail with reference to the accompanying drawings. In the following description, a detailed explanation of known related functions and constructions may be omitted to avoid unnecessarily obscuring the subject matter of the present invention. The present invention may, however, be embodied in many different forms and should not be construed as limited to the exemplary embodiments set forth herein. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention. The same reference numbers are used throughout the drawings to refer to the same or like parts. Furthermore, although the drawings represent exemplary embodiments of the invention, the drawings are not necessarily to scale and certain features may be exaggerated or omitted in order to more clearly illustrate and explain the present invention.

Particular terms may be defined to describe the invention in the best manner without limiting the subject matter of the present invention. Accordingly, the meaning of specific terms or words used in the specification and the claims should not be limited to the literal or commonly employed sense, but should be construed in accordance with the spirit of the invention. In the description, the singular forms “a”, “an”, and “the” include plural referents unless the context clearly dictates otherwise. The terms “include”, “comprise” and “have” or variations thereof are meant to encompass the items listed thereafter and equivalents thereof as well as additional items.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among terms set forth herein, data refers to any kind of information processed by the device, including text and/or images received from any external entities, messages transmitted or received, and information created when a specific function is executed by the device.

The present invention is applicable to a memo input and a memo search in a mobile terminal supporting a memo function.

The present invention may be applied to any information appliance supporting a memo function, such as a smartphone, a portable terminal, a mobile terminal, a personal digital assistant (PDA), a portable multimedia player (PMP), a laptop computer, a notepad computer, a WiBro terminal, a smart TV or a smart refrigerator, and to other devices or services known in the art using speech and pattern recognition.

In the description herein, the term “memo” refers to any drawing, a character, a symbol, and/or portions thereof, and collections of such drawings, characters, symbols, and/or portions thereof.

In the description herein, the words “input information” refer to digital information on touch inputs or touch gestures of a user, which may be collected using a sensor or processing module. For a touch gesture, input information may be related to touch time, length of movement of the contact with the sensor or processing module from the touch gesture by the user's finger or stylus, speed of the movement of the contact, speed change, pressure from the touch by the user's finger or stylus, pressure change, width of the user's finger or stylus during the touch, width change, and other information.

The words “search database” refers to a database, dictionary, index data or index database that contains information needed to perform a memo search. A search database may contain information on memos and input information corresponding to a memo.

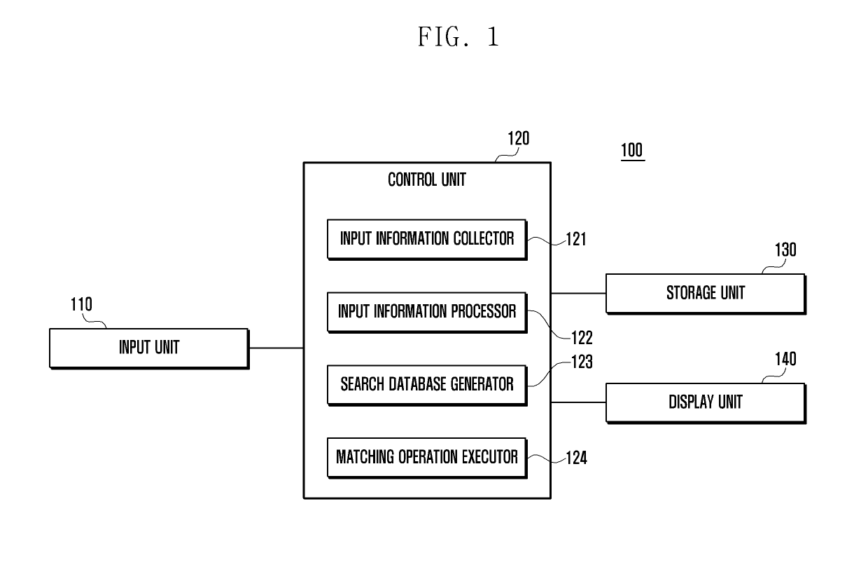

FIG. 1 is a block diagram of a mobile terminal 100 supporting a memo search according to an exemplary embodiment of the present invention.

Referring to FIG. 1, the mobile terminal 100 may include an input unit 110, a control unit 120, a storage unit 130, and a display unit 140.

The input unit 110 may generate an input signal corresponding to user manipulation for controlling operation of the mobile terminal 100. The input unit 110 may also generate an input signal corresponding to a touch action of the user. The input unit 110 may include a touch sensor or proximity sensor to sense a user touch input. Here, the touch sensor may take the form of a touch film, touch sheet or touch pad, or any known components and devices for providing a touch sensor including touch screens such as resistive or capacitive touch screens.

The input unit 110 may sense a touch input and send a touch signal corresponding to the touch input to the control unit 120. The control unit 120 may analyze the touch signal and perform a corresponding operation. Information indicated by the touch signal may be displayed on the display unit 140. The input unit 110 may sense a touch input of the user with input tools such as fingers and stylus pens.

In particular, the input unit 110 may receive memo data and a search word for a memo search from the user. The input unit 110 may receive a memo write request, a memo search request, a memo save request, and the like.

The control unit 120 may control overall operations of internal components of the mobile terminal 100. For example, the control unit 120 may activate a memo application or an application or service accepting a memo input and perform control operations needed for memo writing or a memo search. The control unit 120 may include an input information collector 121, an input information processor 122, a search database generator 123, and a matching operation executor 124.

The input information collector 121 may collect information on a touch input of the user. For example, the input information collector 121 may collect information on a touch input for writing a memo or for entering a search word. The input information collector 121 may collect input information at regular intervals.

The input information collector 121 may include a time measurement module, a length measurement module, and an electronic medical records (EMR) sensor sensing input pressure or width of the touch input. When the input unit 110 is a device wirelessly communicable with the mobile terminal 100, the input information collector 121 may collect input information through a wireless communication module of the mobile terminal 100.

Input information may include at least one of input time, length, speed, speed change, pressure, pressure change, width and width change. Input information may include information created when a memo is written and information derived therefrom.

The input information collector 121 may collect additional input information on the basis of already collected input information. For example, when input information including input time and length is collected, the input information collector 121 may collect information on input speed and speed change on the basis of input time and length. When information on input length is repeatedly collected during a preset period, the input information collector 121 may collect information on input speed and speed change on the basis of the period and input length. The input information collector 121 may collect information on input speed, speed change, pressure change, and width change on the basis of results of operations performed by the input information processor 122.

The input information processor 122 may perform mathematical operations on input information. That is, the input information processor 122 may derive additional input information from the input information collected by the input information collector 121 using predetermined relationships and equations. For example, when input information includes input time and length, the input information processor 122 may calculate at least one of input speed and speed change on the basis of input time and length. When information on input length is repeatedly collected during a preset period, the input information processor 122 may calculate input speed and speed change on the basis of the period and input length. When input information includes input pressure and width, the input information processor 122 may calculate input pressure change and width change. The input information processor 122 may forward calculated results to the input information collector 121 or the search database generator 123.

The search database generator 123 may create a search database on the basis of the input information. That is, the search database generator 123 may receive input information including input time, length, speed, speed change, pressure, pressure change, width and width change from the input information collector 121 or the input information processor 122, and create a search database on the basis of the received input information.

The search database generator 123 may create a search database on the basis of memo input data. Memo data may include at least one of body data, title data and index data. Here, index data may indicate a location within the mobile terminal 100 in which the memo is stored.

The matching operation executor 124 may perform matching operations on a search database on the basis of input information regarding a user touch input. For example, the matching operation executor 124 may perform a matching operation to check whether input information regarding a search word is present in the search database. The matching operation executor 124 may perform a matching operation by using known character or character string matching algorithms. The matching operation executor 124 may perform a matching operation by using a known pattern matching algorithm, a known feature point matching algorithm or a known function matching algorithm.

In one exemplary embodiment, when a memo is written, the control unit 120 may collect input information through the input information collector 121 and input information processor 122, create a search database using the search database generator 123, and store the memo and the search database in an associated form in the storage unit 130. That is, the memo and the search database are associated with each other, such that the memo corresponds to the search database and any information stored therein. The search database may be a record or a set of records of data or other information associated with a corresponding memo or a plurality of memos. In addition, once one search database or record for one memo is created, additional records for other memos may be added to the single search database. Accordingly, in one exemplary embodiment of the present invention, the term “search database”, as used herein, is defined as a record capable of being stored in a general database.

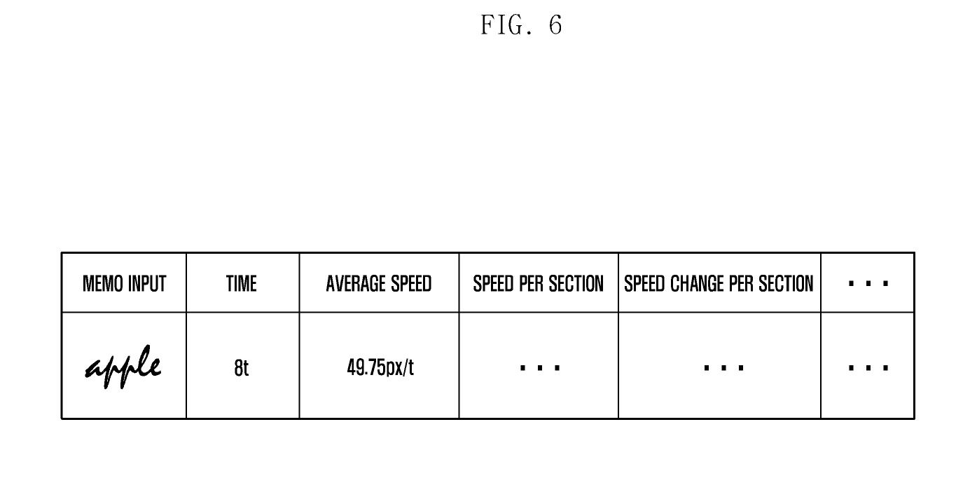

(Comment—The term “search database” associated with a memo, as used throughout the application, appears to refer to a “record”, which is a term known in the art for databases. FIG. 6 would be a typical example of a record. Accordingly, we recite that the search database may including many records of different memos. Please confirm or provide an alternative explanation.)

When a search word is input for a memo search, the control unit 120 may collect input information of the search word through the input information collector 121 and input information processor 122, and determine whether a memo matching the search word is present in the search database through the matching operation executor 124.

Operations of the control unit 120 are described later in more detail with reference to the drawings.

The storage unit 130 may store programs or commands necessary for operation of the mobile terminal 100. The control unit 120 may execute the programs or commands stored in the storage unit 130. The storage unit 130 may include one or more of various types of storage media, such as flash memory, a hard disk, a multimedia or other memory card (micro SD or XD), random access memory (RAM), static random access memory (SRAM), read only memory (ROM), programmable read-only memory (PROM), electrically erasable programmable read-only memory (EEPROM), magnetic memory, a magnetic disk, and an optical disc.

In particular, the storage unit 130 may temporarily or semi-permanently store input information corresponding to a received user touch input through the input unit 110 and/or the display unit 140 having a touch screen. The storage unit 130 may store input information related to the user touch input for writing a memo or entering a search word. The storage unit 130 may store a search database created on the basis of input information. The control unit 120 may update and manage the search database stored in the storage unit 130.

The display unit 140 displays information processed or to be processed by the mobile terminal 100. The display unit 140 may display a user interface (UI) or graphical user interface (GUI) related to the memo function.

In particular, when a memo is written, the display unit 140 may display the memo. When a search word is entered, the display unit 140 may display the search word and memo search results. The display unit 140 may display memo search results as a list or memo body data. When memo body data is displayed, words or items matching the search word may be shaded, bolded, underlined, or italicized for highlighting.

The display unit 140 may be implemented using one or more of known display techniques based on a liquid crystal display (LCD), a thin film transistor liquid crystal display (TFT-LCD), organic light emitting diodes (OLED), a flexible display, and a three-dimensional (3D) display. When the display unit 140 is layered with or includes the touch sensor of the input unit 110, the display unit 140 may act as a touchscreen. In this case, the display unit 140 may be regarded as an input device as well as a display device, and may also include the input unit 110.

As the components of the mobile terminal 100 shown in FIG. 1 are not limited to implementing functions and applications of the exemplary embodiments of the present invention, a new component may be added or an existing component may be excluded or replaced to implement the present invention as well as other known functions and applications.

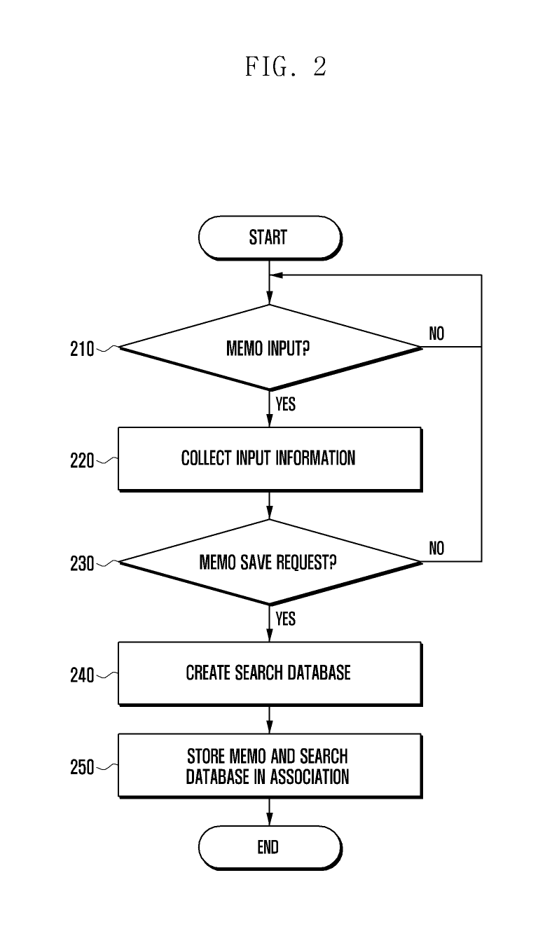

FIG. 2 is a flowchart of a memo input procedure for a memo search according to another exemplary embodiment of the present invention.

Referring to FIG. 2, the mobile terminal 100 checks for an occurrence of a memo input in step 210. Memo input may occur when an application supporting a memo function is executed or when the user writes a memo during a lock state, a power saving state, or an idle state.

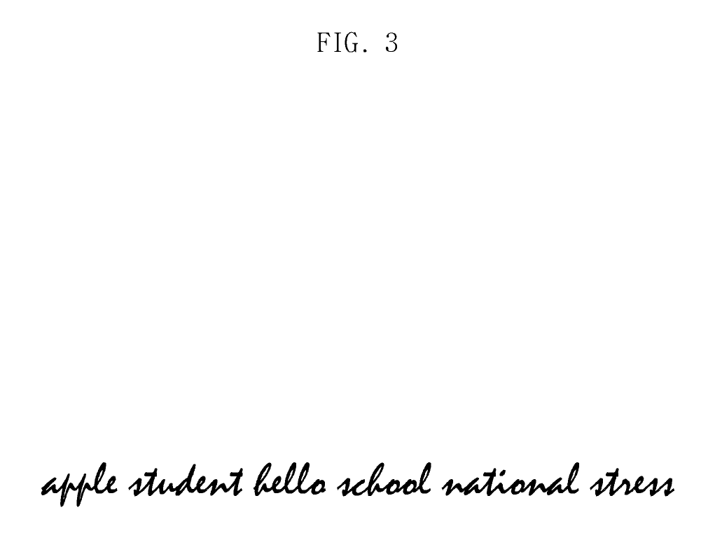

An input memo may be written in Korean characters, English characters, Japanese characters, special characters, numbers, and any other known alphabets, characters, and symbols, as well as drawings, together with various typefaces such as print and cursive letters. For example, FIG. 3 shows a memo “apple student hello school national” in cursive English letters.

When a memo is written, the mobile terminal 100 may recognize the pattern of the memo or recognize characters corresponding to the shape of the memo or portions thereof.

While a memo input occurs, the mobile terminal 100 collects input information for the input memo in step 220. When the user writes a memo though a touch input, input information including input time, length, speed, speed change, pressure, pressure change, width and width change may be collected during the writing by the user. Input information may vary with time during the memo input.

The mobile terminal 100 may collect input information specific to the user. Here, input information may include at least one of input time, length, pressure, width, speed, speed change, pressure change and width change, and may further include other known information. The mobile terminal 100 may repeatedly collect input information during a preset period during the memo input. The preset period may be determined in consideration of memo search accuracy and processing speed and storage capacity of the mobile terminal 100.

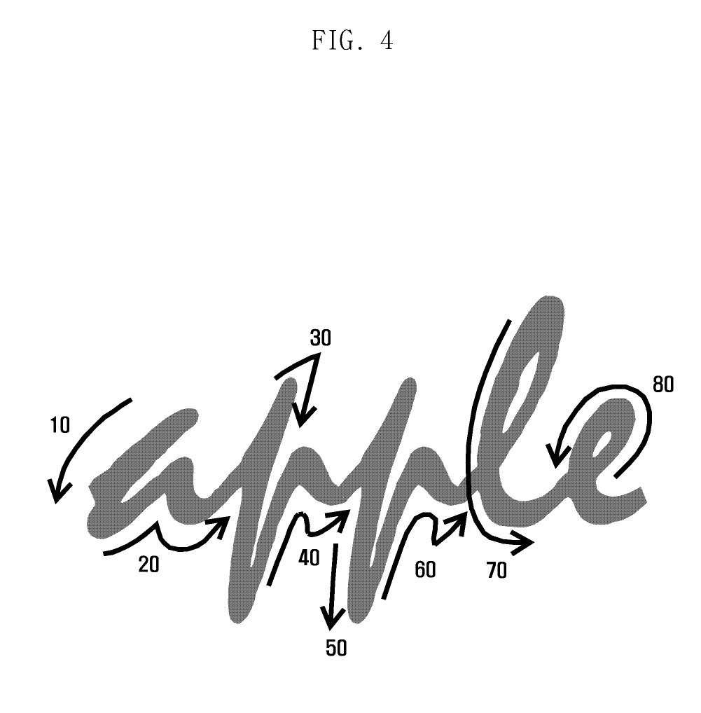

Referring to FIG. 4, when the memo “apple student hello school national” is input as shown in FIG. 3, input information for the input memo may be collected. In the case of a period of 1 second, the mobile terminal 100 may collect input information every second. For example, in the memo “apple student hello school national”, when “apple” is input for eight periods (8 seconds), eight measurements for touch gestures 10-80 made during the eight periods may be collected as input information.

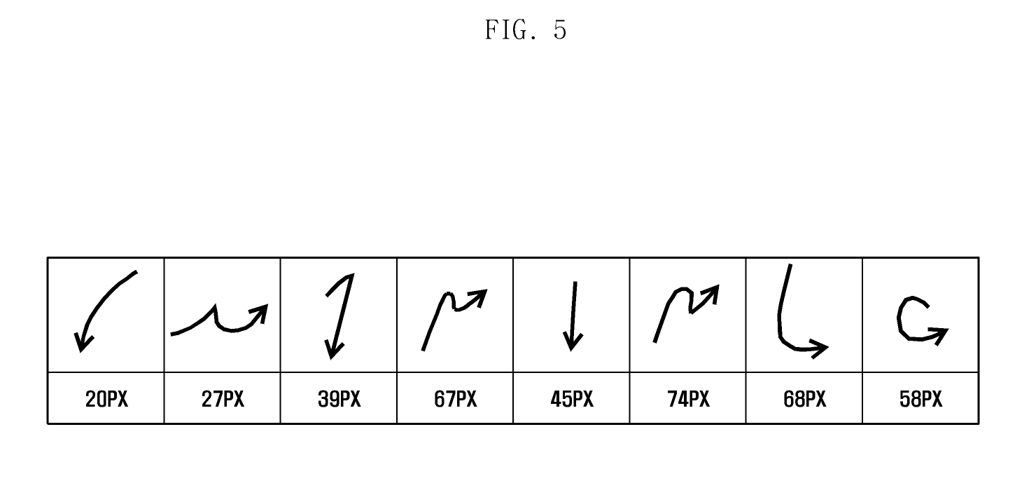

Referring to FIG. 5, the mobile terminal 100 may collect input information related to shapes and lengths of touch gestures made during each of the first through eighth periods. For example, for a touch input at the first period, the mobile terminal 100 may collect a touch shape, an input time of 1 second and an input length of 20 pixels (PX) as input information.

The mobile terminal 100 may extract additional input information through mathematical operations on the already collected input information. For example, the mobile terminal 100 may derive at least one of input speed, speed change, pressure change, and width change from collected input information including input time, length, pressure and width. These operations may be performed at the creation time of the search database, and are described in more detail later.

The mobile terminal 100 may display the input memo as well as the collected input information.

Thereafter, the mobile terminal 100 determines whether a memo save request is received in step 230. A memo save request may be issued by the user through the input unit 110 and/or the display unit 140 having a touch screen, or by a preset automatic save feature for synchronization.

When a memo save request is received, the mobile terminal 100 creates a search database in step 240. If necessary, a search database may be created automatically without requiring receipt of a memo save request.

A search database may store multiple pieces of input information each including at least one of input time, length, speed, speed change, pressure, pressure change, width and width change. In addition, the search database may store multiple pieces of memo data each having at least one of body data, title data and index data. Here, index data may indicate a location within the mobile terminal 100 in which the corresponding memo is stored.

The mobile terminal 100 may create a search database on the basis of input information. When input information is collected during a preset period, the mobile terminal 100 may create a search database on the basis of periodically collected input information.

Referring to FIG. 5, the mobile terminal 100 may collect information on a memo input, including touch time and length for the touch gestures 10 to 80 input during the first through eighth periods as input information. The mobile terminal 100 may create a search database or record on the basis of collected input information including the memo input, input time measured in predetermined units of time “t”, and length, with example data entries as illustrated in FIG. 6.

The mobile terminal 100 may extract additional input information from already collected input information, and create a corresponding search database. For example, the mobile terminal 100 may derive at least one of input speed, speed change, pressure change, and width change from collected input information including input time, length, pressure and width, and create a corresponding search database.

Referring to FIG. 6, when input information is related to input time and length, the mobile terminal 100 may compute at least one of input speed and speed change on the basis of input time and length.

Specifically, the mobile terminal 100 may compute input speed from input time and length as given by Equation 1:

input speed=input length/input time. (1)

Referring to the input information in FIG. 5, the input time is 8 seconds for the first through eighth periods, and the input length is 398 (20+27+39+67+45+74+68+58) pixels. Hence, the input speed for the memo input of “apple” is evaluated to be 49.75 pixels per unit time (px/t) by Equation 1.

The mobile terminal 100 may compute an input speed per period on the basis of input time and length. Referring to the input information in FIG. 5, the input speed per period can be computed using Equation 1 as shown in Table 1.

TABLE 1

| | | | | | | | Peri- |
|---|---|---|---|---|---|---|---|
| Period 1 | Period 2 | Period 3 | Period 4 | Period 5 | Period 6 | Period 7 | od 8 |
| 20 | 27 | 39 | 67 | 45 | 74 | 68 | 58 |

The mobile terminal 100 may represent relative input speed as ratios of the input speed per period to overall input speed; that is, the input speeds are normalized to be relative input speeds. Accordingly, the mobile terminal 100 may compute a speed ratio using Equation 2 and use speed ratios as the relative input speeds.

relative input speed=speed ratio=input speed per period/overall input speed. (2)

Referring to input information in FIG. 5, speed ratios as relative input speeds can be computed using Equation 2 as in Table 2 on the basis of the input speed per period given in Table 1 and overall input speed of 49.75.

TABLE 2

| | | | | | | | Peri- |
|---|---|---|---|---|---|---|---|
| Period 1 | Period 2 | Period 3 | Period 4 | Period 5 | Period 6 | Period 7 | od 8 |
| 0.40 | 0.54 | 0.78 | 1.35 | 0.90 | 1.49 | 1.37 | 1.17 |

The mobile terminal 100 may compute an input speed change on the basis of changes in input speed per period. Input speed change may be computed using Equation 3.

$$speed change = input speed at previous period - input speed at current period . \qquad ( 3 )$$

Referring to the input information in FIG. 5, the speed change may be computed as in Table 3 on the basis of the relative input speeds, applied to Equation 3, and the input time given by Table 1 or Table 2, with the speed change for the first period being set to be the relative speed in that first period, since Equation 3 cannot be applied to Period 1. Alternatively, the speed change for the first period may be set by default to be zero.

TABLE 3

| | | | | | | | Peri- |
|---|---|---|---|---|---|---|---|
| Period 1 | Period 2 | Period 3 | Period 4 | Period 5 | Period 6 | Period 7 | od 8 |
| 0.40 | +0.14 | +0.24 | +0.57 | −0.45 | +0.59 | −0.12 | −0.20 |

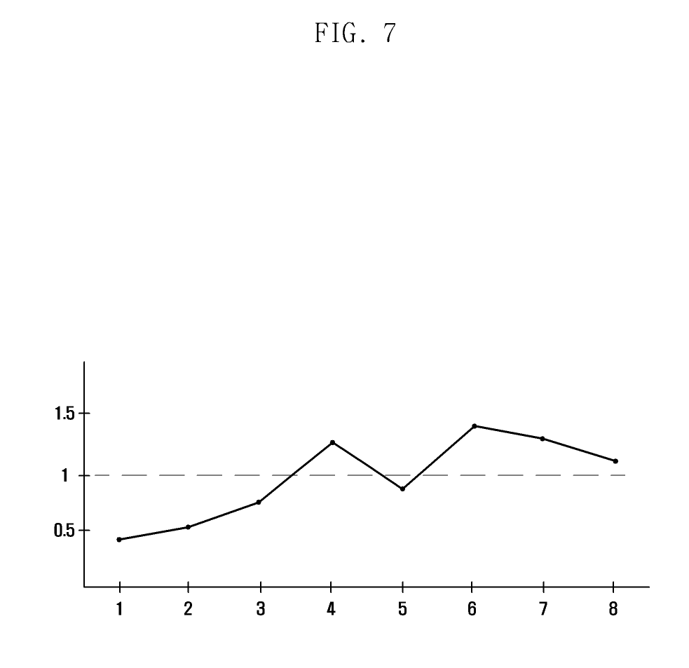

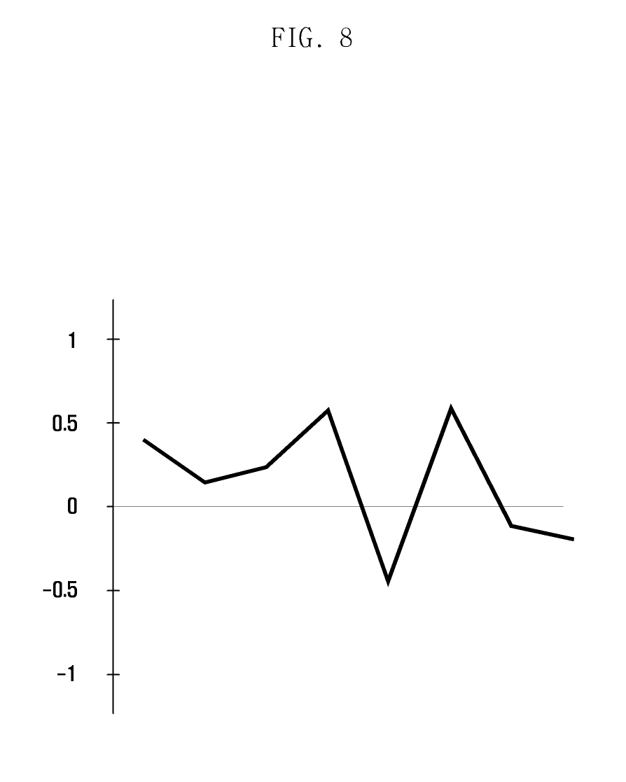

FIG. 7 illustrates a graph of relative input speed as computed above in Table 2, and FIG. 8 illustrates a graph of input speed change as computed above in Table 3, with the graphs of FIGS. 7-8 measured over the eight periods.

The mobile terminal 100 may create a search database and/or a record associated with a memo and its input information, as illustrated in FIG. 6 on the basis of input speed, input speed per period, and input speed change as computed above. The search database and/or record shown in FIG. 6 may be assembled together with other search databases or records of a plurality of memos.

The above operations may be performed during the collection of input information, and the mobile terminal 100 may create a search database on the basis of results of operations performed during the collection of input information.

Finally, referring to FIG. 2, the mobile terminal 100 stores the memo and the search database in an associated form in step 250; that is, the memo and any associated input information and calculations therefrom are saved and indexed in the search database. The mobile terminal 100 may store the input memo in response to a memo save request issued by the user or by a preset automatic save feature for synchronization.

The mobile terminal 100 may store the search database created during the memo input. The mobile terminal 100 may associate the memo and the search database by creating the search database on the basis of the memo information. The memo information may include at least one of memo body data, title data and index data corresponding to input information contained in the search database, and the index data may indicate a location within the mobile terminal 100 at which the corresponding memo is stored.

Hereinabove, use of input speed and speed change for a memo input is illustrated. However, the present invention is not limited thereto. The input speed, pressure, and width may be used individually or in combination with other data to be the input information, and a search database may be created using such input information.

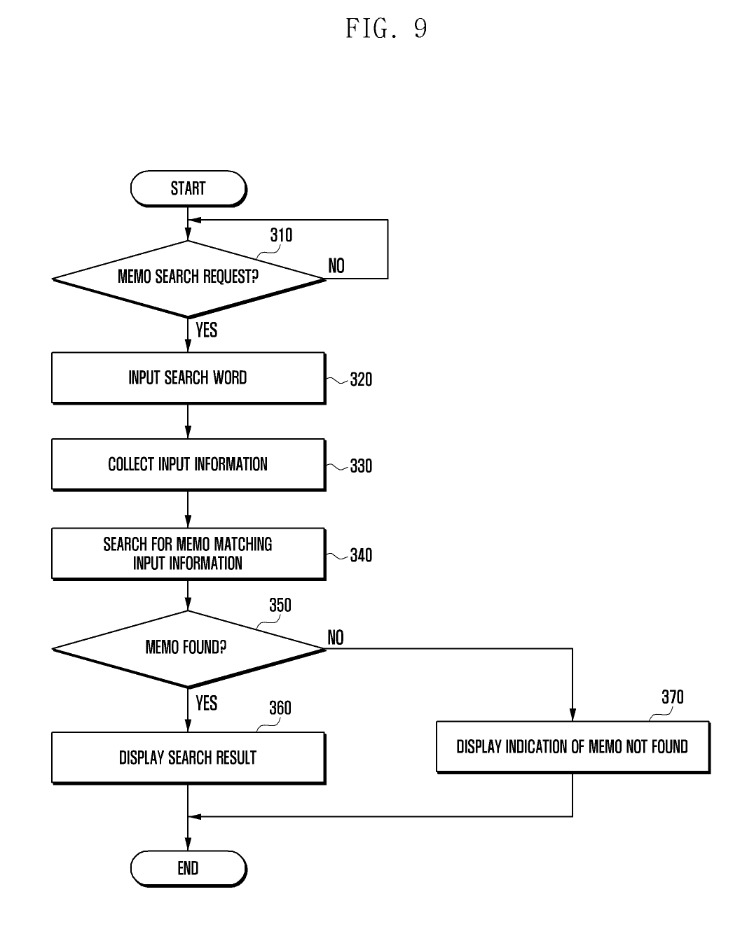

Next, a description is provided of a memo search with reference to FIG. 9.

FIG. 9 is a flowchart of a memo search method according to another exemplary embodiment of the present invention.

Referring to FIG. 9, the mobile terminal 100 checks whether a memo search request is received in step 310, for example, through the input unit 110 and/or the display unit 140 having a touch screen. A memo search request may be issued by the user or an application or service provided by the mobile terminal 100.

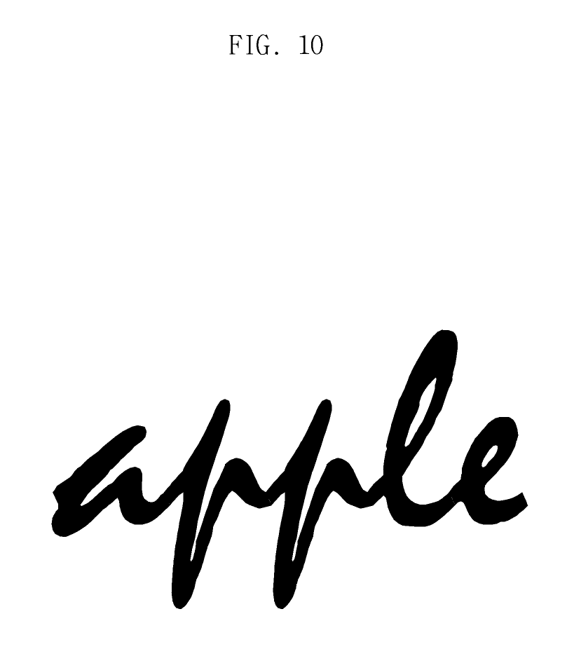

When a memo search request is received, the mobile terminal 100 receives a search word for a memo search in step 320. For example, the mobile terminal 100 may receive a search word “apple”, as shown in FIG. 10, through the input unit 110 and/or the display unit 140 having a touch screen.

The mobile terminal 100 collects input information for the search word in step 330. For a touch input for the search word, in a manner similar to memo writing described herein, an input time, length, pressure, width, speed, speed change, pressure change, and width change may be collected as input information during the writing by the user. Input information may vary with time during a search word input.

Input information for a search word may include at least one of input time, length, pressure, width, speed, speed change, pressure change and width change. The mobile terminal 100 may repeatedly collect input information during a preset period during search word input.

The mobile terminal 100 may extract additional input information through mathematical operations on the already collected input information. For example, the mobile terminal 100 may compute at least one of input speed, speed change, pressure change, and width change from collected input information including input time, length, pressure and width. Operations to collect input information are described herein in connection with FIGS. 4 to 8.

The mobile terminal 100 may display the search word on the display unit 140 as well as collect input information for the search word.

The control unit 120 performs a memo search to find a memo matching the input information in step 340. The mobile terminal 100 may find a memo corresponding to the input information of the search word from the search database. The mobile terminal 100 may check whether input information corresponding to the input information of the search word is present in the search database through matching operations.

The mobile terminal 100 may perform a matching operation between input information of the search word and input information contained in the search database by using known character or character string matching algorithms. The mobile terminal 100 may perform a matching operation by using a known pattern matching algorithm, a known feature point matching algorithm or a known function matching algorithm. The mobile terminal 100 extracts memos corresponding to the input information of the search word as search results on the basis of matching results.

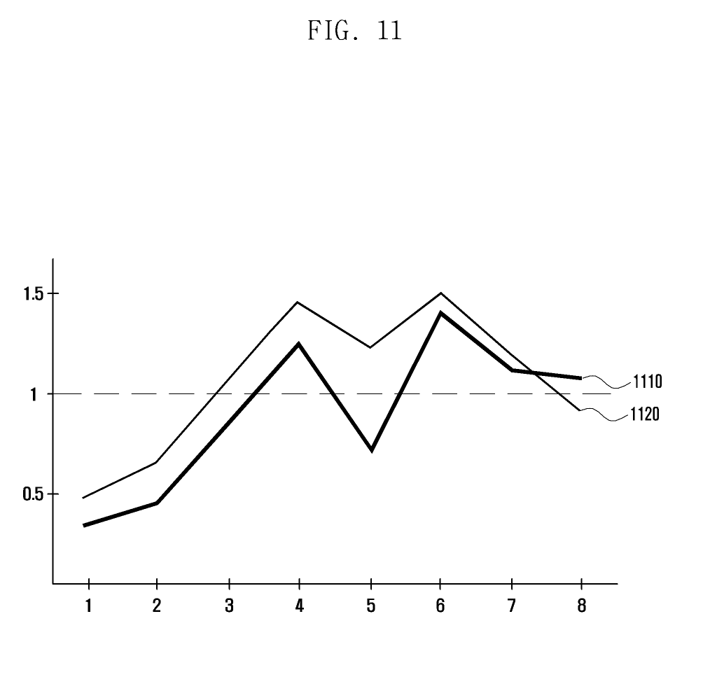

Instead of finding matches based on identical input information, similarity between input information of the search word and input information contained in the search database may be used for a matching operation. For example, referring to FIG. 11, in the case where matching is performed in terms of input speed per period, when a graph 1110 of input speed per period contained in the search database is similar to a graph 1120 of input speed per period for the search word, the mobile terminal 100 may determine that the search word and the data in the search database correspond to each other. To find input information similar to that of a search word, the mobile terminal 100 may pre-store information regarding similarity criteria, similarity thresholds, scoring schemes, and the like.

The mobile terminal 100 may obtain a memo search result corresponding to the input information in the search database matching the input information of the search word. Specifically, the mobile terminal 100 may obtain memo information corresponding to the matched input information in the search database, obtain at least one of memo body data, title data and index data of the memo information, and locate the corresponding memo stored within the mobile terminal 100 using the index data.

Referring back to FIG. 9, the mobile terminal 100 checks whether a memo matching the search word is present on the basis of memo search results in step 350. The mobile terminal 100 may determine that a memo matching the search word is present in the search database when memo information corresponding to input information of the search word is obtained.

When a memo matching the search word is present, the mobile terminal 100 displays the memo search result in step 360 and ends the method; otherwise, the method proceeds to step 370. The mobile terminal 100 may display the memo search result on the basis of the obtained memo information. That is, the mobile terminal 100 may display memo body data or title data indicated by the memo information, or display a stored memo located using the index data.

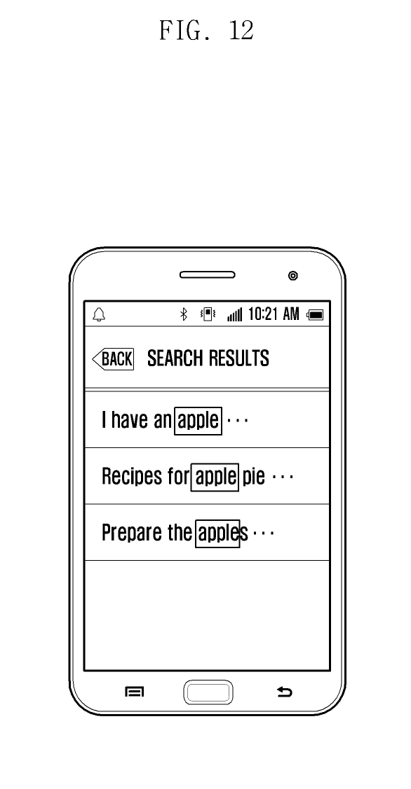

Referring to FIG. 12, the mobile terminal 100 may display the memo search results corresponding to the search word as a list. Here, memo titles, portions of memo bodies or portions of memo bodies containing the search word may be displayed in a list form. Memo words or items matching the search word may be shaded, bold, underlined, or italicized for highlighting, such as the lines forming borders around the matched search word “apple” in FIG. 12, which represent such shading or other known types of visual indicators such as highlighting.

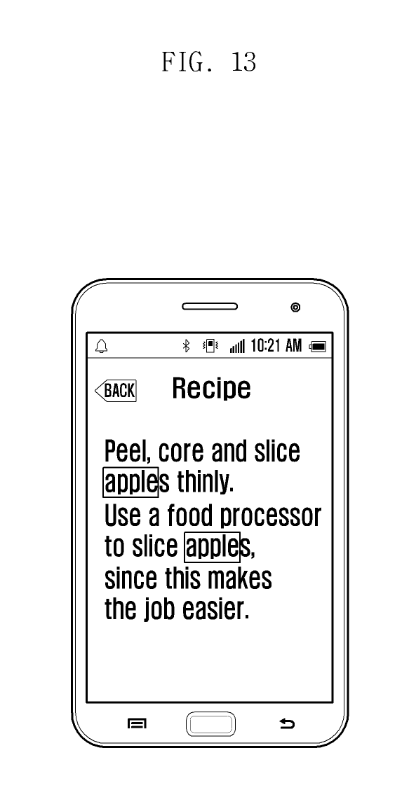

Referring to FIG. 13, the mobile terminal 100 may display a memo corresponding to the search word. The mobile terminal 100 may display a particular memo among the list of search results in response to a selection request, for example, a selection of one of the search results in the list shown in FIG. 12. A memo and related information such as the title may be displayed together. Memo words or items matching the search word may be shaded, bold, underlined, or italicized for highlighting, such as the lines forming borders around the matched search word “apple” in FIG. 13, which represent such shading or other known types of visual indicators such as highlighting.

The mobile terminal 100 may display a GUI box or window containing a list of selectable actions, which may be applied by the user to the list of searched memos, such as memo add, memo edit, text messaging or e-mail messaging, together with the memo list.

Referring back to FIG. 9, when a memo matching the search word is not present as determined in step 350, the mobile terminal 100 displays a notification or other forms of alerts or messages indicating an absence of a matching memo in 370. The mobile terminal 100 may display a message, image or emoticon indicting absence of a matching memo through a notification or popup window.

In the above description, use of input speed and speed change for a memo input is illustrated. However, the present invention is not limited thereto. The input speed, pressure, and width may be used individually or in combination as input information, and a search database may be created using such input information.

In the exemplary embodiments of the present invention, the memo search method enables the user of a mobile terminal to accurately find a desired memo on the basis of input information collected during the memo writing.

As the memo search method is based on input information collected during memo writing, the memo search method of the present invention can find a desired memo among various types of memos written in Hangul characters, drawings, cursive English letters or Arabic alphabets, or any other known system of writing.

The above-described apparatus and methods according to the present invention can be implemented in hardware, firmware or as software or computer code that can be stored in a recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any media such as communication signals transmitted by wire/wireless connections, and their equivalents.

Although exemplary embodiments of the present invention have been described in detail hereinabove, it should be understood that many variations and modifications of the basic inventive concept described herein will still fall within the spirit and scope of the present invention as defined in the appended claims.

What is claimed is:

1. A memo search method comprising:
collecting, when a memo is input, input information on the memo;
creating a search database on the basis of the input information; storing the memo and the search database associated with the memo; and
responding to a search request of the search database and outputting a corresponding memo.

2. The memo search method of claim 1, wherein the input information comprises information obtained from the memo input and information derived therefrom, and is related to at least one of input time, length, speed, speed change, pressure, pressure change, width and width change.

3. The memo search method of claim 1, wherein the search database contains input information including information obtained from the memo input and information derived therefrom and is related to at least one of input time, length, speed, speed change, pressure, pressure change, width and width change, and memo information corresponding to the input information.

4. The memo search method of claim 1, wherein creating a search database comprises:
computing, when the input information includes the input time and the length, at least one of input speed and speed change on the basis of the input time and the length; and
creating a search database on the basis of the input information and the computation results.

5. The memo search method of claim 1, wherein collecting input information on the memo comprises collecting input information during a preset period during the memo input, and wherein creating a search database comprises creating a search database on the basis of the input information collected during the preset period.

6. The memo search method of claim 1, wherein creating a search database comprises:
computing, when the input information includes an input length per period collected during a preset period, at least one of an input speed and a speed change per period on the basis of the input length per period; and
creating a search database on the basis of the input information and the computation results.

7. The memo search method of claim 1, further comprising:
inputting a search word for a memo search;
collecting input information on the search word;
searching the search database for a memo matching the input information; and
displaying the memo search results.

8. The memo search method of claim 7, wherein searching the search database for the memo comprises:
performing pattern matching between the input information of the search word and the search database; and
obtaining the memo search results on the basis of the pattern matching results.

9. The memo search method of claim 1, wherein the input information is information on a touch input with a finger or a pen.

10. A memo search method comprising:
inputting a search word for a memo search;
collecting input information on the search word;
searching a search database containing input information on stored memos for a specific memo matching the input information on the search word to obtain corresponding memo search results; and
displaying the memo search results.

11. The memo search method of claim 10, wherein collecting the input information comprises collecting the input information on the search word during a preset period during the search word input.

12. The memo search method of claim 10, wherein searching the search database comprises:
computing, when the input information includes an input time and a length, at least one of a input speed and a speed change on the basis of the input time and the length; and
searching the search database for a matching memo on the basis of the input information and the computation results.

13. The memo search method of claim 10, wherein searching a search database comprises:
performing pattern matching between the input information of the search word and the search database; and
obtaining the memo search results on the basis of the pattern matching results.

14. A mobile terminal comprising:
an input unit receiving user input;
a storage unit storing data;
a control unit collecting, when a memo is input through the input unit, input information on the memo, creating a search database on the basis of the input information, storing the memo and the search database in an associated form in the storage unit, and responding to a search request of the search database; and
an output unit for outputting a memo corresponding to the search request.

15. The mobile terminal of claim 14, wherein the control unit computes, when the input information includes an input time and a length, at least one of an input speed and a speed change on the basis of the input time and the length, and creates the search database on the basis of the input information and the computation results.

16. The mobile terminal of claim 14, wherein the output unit further comprises a display unit displaying data, and wherein the control unit collects, when a search word for a memo search is input through the input unit, input information on the search word, searches the search database for a memo matching the input information, and controls the display unit to display the memo search results.

17. The mobile terminal of claim 16, wherein the control unit performs pattern matching between the input information of the search word and the search database, and obtains the memo search results on the basis of the pattern matching results.
